(19) United States
(12) Patent Application Publication
(10) Pub. No.: US 2024/0051279 A1
(43) Pub. Date: Feb. 15, 2024

(54) COMPOSITE MATERIAL AND METHOD FOR FORMING THE COMPOSITE MATERIAL

(71) Applicant: DUPONT SPECIALTY PRODUCTS USA, LLC, Wilmington, DE (US)

(72) Inventor: TAKUYA MIYAUCHI, Tochigi (JP)

(21) Appl. No.: 18/264,874

(22) PCT Filed: Feb. 10, 2022
(86) PCT No.: PCT/US2022/070598

§ 371 Date: Aug. 9, 2023

Related U.S. Application Data
(60) Provisional application No. 63/156,415, filed on Mar. 4, 2021.

(51) Int. Cl. B32B 27/12; C08J 5/12; C08J 5/24; B32B 5/02; B32B 27/32; B32B 5/26; B32B 7/027; B32B 27/08

(52) U.S. Cl. CPC B32B 27/12; C08J 5/128; C08J 5/243; B32B 5/02; B32B 27/322; B32B 5/26; B32B 7/027; B32B 27/08; C08J 2363/00; C08J 2327/18; C08J 2327/22; C08J 2463/00; B32B 2262/106; B32B 2250/05; B32B 2307/7376; B32B 2307/308; B32B 2307/714; B32B 2260/023; B32B 2260/046; B29C 43/203

(57) ABSTRACT

a composite material having (A) a base layer containing perfluoroalkoxy alkane and carbon fiber, (B) an intermediate layer and (C) a polytetrafluoroethylene cover layer, wherein the intermediate layer contains perfluoroalkoxy alkane is disclosed.

### FIELD OF DISCLOSURE

This invention relates to a composite material having perfluoroalkoxy alkane (PFA) base layer and polytetrafluoroethylene (PTFE) cover layer, those are bonded to one another by PFA intermediate layer.

### BACKGROUND

Fiber reinforced PFA is known as a structural material for semiconductor manufacturing equipment. Such fiber reinforced PFA can be molded to obtain any shapes useful as the equipment. One practical method to obtain fiber reinforced PFA is disclosed in WO2011/002883A, which discloses a composite article comprising fluoropolymer and carbon fiber, and a process for making the composite article.

Although fiber reinforced PFA is excellent material because of its mechanical properties, heat resistance and chemical resistance, when the material is exposed to strong acid, reinforcing fibers bared on the surface of the material are oxidized and degraded by the strong acid. This results in deterioration of property of material. The degraded reinforcing fibers can easily drop off from material and cause contamination problem. In addition, gas generated through oxidization swells surface of material under high temperature.

WO2009/110341A discloses a member made by PFA and PTFE those comprise carbon powders or carbon fibers as reinforcing materials, in which the carbon powders/fibers on the surface of the member is removed comparing with the inner part of the member, by contacting the member with oxidizing gases. However, this process requires several additional steps after machining of part, such as immersion in oxidizing gas and re-heating material to or over softening temperature.

Therefore, further improvement of fiber reinforced PFA material with acid resistance is still required in the semiconductor technology.

### SUMMARY

Accordingly, one aspect of the invention is a composite material comprising (A) a base layer comprising perfluoroalkoxy alkane and carbon fiber, (B) an intermediate layer and (C) a polytetrafluoroethylene cover layer, wherein the intermediate layer comprises perfluoroalkoxy alkane.

Other aspects of the invention are two processes for preparing a composite material disclosed above. The first process comprising the steps of: (a) preparing consolidated mats comprising PFA and carbon fiber, (b) setting a cover layer, an intermediate layer and the multiple consolidated mats in a mold, then (c) hot press the three components in the mold to form a composite material.

The second process for preparing a composite material disclosed above comprises the steps of: (d) preparing consolidated mats comprising PFA and carbon fiber, (e) setting multiple consolidated mats in a mold, (f) hot press the multiple consolidated mats to form a molded material, (g) setting a cover layer, an intermediate layer and the molded material obtained by the step (f) in a mold, then (h) hot press the three components in the mold to form a composite material.

Further aspect of the invention is an article formed from the composite material described above.

### DETAILED DESCRIPTION

The present invention relates to a composite material comprising: (A) a base layer comprising perfluoroalkoxy alkane (PFA) and carbon fiber, (B) an intermediate layer and (C) a polytetrafluoroethylene (PTFE) cover layer, in which the intermediate layer comprises perfluoroalkoxy alkane.

(A) PFA Base Layer

PFA base layer comprises PFA and carbon fiber. It is also called as carbon fiber reinforced PFA. Such material is known in the art and can be used in the invention. For example, WO2011/002883A discloses a consolidated composite article comprising fluoropolymer and carbon fiber. In the disclosure, PFA mats containing carbon fibers are firstly prepared, then the PFA mats are stacked then molded to form a composite article.

Any kind of PFA can be used. In general, PFA has coefficient of linear expansion 120 to 200×10⁻⁶/degrees C. by ASTM E831, and 2 to 17 g/minutes of melt flow index (MFI) by ASTM D1238. PFA can be obtained in commercial, for example, Teflon™ PFA with MFI of 2 to 15 g/minutes provided by Chemours-Mitsui Fluoroproducts Co., Ltd.

In the present invention, carbon fiber is used as reinforcing material of the PFA base layer. Carbon fiber has an advantage over other fibric materials made by inorganic chemicals such as SiC, because of its softer property and easier to obtain in commercial, compare with such inorganic fibers.

Carbon fiber can be obtained in commercial, for example, TORAYCA™ provided by Toray or Tenax™ by Teijin. A typical chopped carbon fiber has 3 to 25 mm of length and 500 to 5,000 of aspect ratio.

Contents of the carbon fiber in the PFA base layer is preferably from 5 to 50 wt %, more preferably from 10 to 30 wt % based on the total weight of the PFA base layer.

PFA base layer can further contain any other additive, such as carbon nanotube, graphite powder and nanodiamond.

The thickness of the PFA base layer is, for example, from 1 to 50 mm, preferably from 15 to 35 mm.

Coefficient of linear expansion in plane perpendicular to the molding direction of the PFA base layer is, preferably from 1 to 20×10⁻⁶/degrees C., more preferably from 2 to 10×10⁻⁶/degrees C. by ASTM E831, the temperature range is from 25 to 260 degrees C.

(B) Intermediate Layer

The base layer and the cover layer are adhered each other by the intermediate layer, and the intermediate layer is a key of the invention. Intermediate layer comprises perfluoroalkoxy alkane (PFA). The PFA used as intermediate layer of this invention can be the same PFA used in PFA base layer, but can be the different PFA which has hundreds of thousands of molecular weight, 2 to 17 g/minutes of MFI by ASTM D1238.

The intermediate layer can further contain additives known in the art, but not needed to contain other additives.

The thickness of the intermediate layer is, preferably from 10 to 2,000 micrometers, more preferably 100 to 2,000 micrometers.

(C) PTFE Cover Layer

PTFE used in the present invention has millions to 10 million of molecular weight as molding grade.

In the specification, PTFE include modified PTFE. Examples of the modified PTFE are, for instance, PTFE modified with perfluoro (alkyl vinyl ether) (PAVE), PTFE modified with hexafluoropropylene (HFP), and the like.

Coefficient of linear expansion of PTFE cover layer is from 120 to 220×10⁻⁶/degrees C. by ASTM E831 in general.

The thickness of the PTFE cover layer is, preferably from 0.1 to 10 mm, more preferably from 0.5 to 5 mm.

Processes to Prepare a Composite Material

There are two processes to prepare the composite material of the invention. The first process is one-step hot press method, while the second process is two-steps hot press method. The first process also disclosed as simultaneous molding process.

The first process (Process 1) has the following steps disclosed (a) to (c) below.
(a) preparing consolidated mats comprising PFA and carbon fiber:
   Firstly, consolidated mats comprising PFA and carbon fiber are prepared. Consolidated mats can be prepared by heating matte comprising PFA and carbon fiber to a temperature above the softening temperatures of the two, then cool it to a temperature less than said softening temperature. Consolidated mats comprising PFA and carbon fiber can be obtained according to the methods disclosed in WO2011/002883A, WO1993/011450 and U.S. Pat. No. 5,506,052A.
(b) setting a cover layer, an intermediate layer and multiple consolidated mats in a mold.
   In the next step, consolidated mats are cut into mold shape and are stacked in specific number in mold. Then an intermediate layer and a cover layer are placed in order on the top of the stacked consolidated mats in a mold. The order to place the three layers in a mold can be reversed.
(c) hot press the three components in the mold to form a composite material.
   Next step is hot-pressing step to form a composite material. Heat and pressure are applied to mold for a sufficient amount of time to form final composite material. The temperature, pressure and time required to do this will vary with such factors as MFI, thickness and fiber loading. An exemplary, the mold is heated over 327 degrees C. (above PTFE's melting temperature), for 30 to 60 minutes at pressure of below 0.5 MPa. Then the mold is cooled to room temperature with higher pressure than initial pressure, and a composite material is obtained.

The second process (Process 2) has the following steps disclosed (d) to (h) below.
(d) preparing consolidated mats comprising PFA and carbon fiber, as the same method mentioned above as step (a),
(e) setting multiple consolidated mats in a mold, same as the step (b) mentioned above, excepting for the intermediate layer and cover layer are not placed on the stacked consolidated mats.
(f) hot press the multiple consolidated mats disclosed above to form a molded material. The stacked consolidated mats are hot-pressed the same manner disclosed as (c) above. After the step, molded material, i.e. molded PFA-carbon fiber material is obtained, without upper layer and intermediate layer.
(g) setting cover layer, intermediate layer and the molded material in a mold.
   Then the molded material obtained by the step (f) is set in a mold. The molded material can be machined into a specific shape which fits the size of a mold, before setting in the mold. Then, an intermediate layer and a cover layer are placed in order on top of the molded material in a mold.
(h) hot press the three components in the mold to form a composite material
   The same conditions as mentioned step (C) are applied for molding of composite material. The temperature, pressure and time required to do this will vary with shape of composite material.

(D) Article

Remarkable properties of the composite material are superior acidic resistance combined with good resistance against thermal shock in spite of layered structure of multiple materials with each coefficient of linear expansion.
The composite material can be used as parts for semiconductor manufacturing equipment, especially for such equipment which is exposed to acidic liquid, for example, wafer cleaning machine, pumps and valves. And also it can be used for chemical processing industry such as CPL production, HF production, TiO₂ production and high pressure acid leach for metal refining in which sulfuric acid is utilized for these process.

### EXAMPLES

Materials similar to the following, and methods for making similar materials and articles, are detailed in US2011/0001082 A, WO2011/002867A, WO2011/002877A and WO2011/002883A all of which are incorporated by reference in their entirety.

### Raw Materials

### PFA (Sheet Type)

A sheet type of PFA, having a melting point of approximately 305 degrees C., a specific gravity of approximately 2.12 to 2.17 by ASTM D1505 and tensile strength of approximately 31.4 to 41.2 MPa by ASTM D882, was used.

### PTFE (Sheet Type)

A sheet type PTFE, having a melting point of approximately 327 degrees C., a specific gravity of approximately 2.13 to 2.20 by ASTM D1505 and tensile strength of approximately 20 to 35 MPa by ASTM D882 was used.

### Modified PTFE (Sheet Type)

A sheet type modified PTFE, having a melting point of approximately 327 degrees C., a specific gravity of approximately 2.13 to 2.20 by ASTM D1505 and tensile strength of approximately 20 to 35 MPa by ASTM D882 was used.

### Examples 1 to 33 (Simultaneous Molding Process, One Step Molding Method)

Consolidated mats were prepared according to the methods of WO2011/002883 A1, diameter of 91.5 mm were cut. Thickness of one consolidated mat is about 0.3 mm and it was made from 20% by weight CF and 80% by weight PFA.

Approximately 60 consolidated mats were stacked one upon the other in a mold. Then, PFA, and PTFE or modified PTFE disclosed in Table 1 were placed in order on the stacked consolidated mats. After that, the stack (i.e. stacked consolidated mats, PFA and PTFE) were put into a mold.

The mold at essentially ambient temperature was placed in a temperature-controlled platen press and heated so that the temperature throughout the stack was greater than 327 degrees C. while the stack was minimally compressed along the thickness direction at a pressure less than 0.5 MPa, while being unconstrained by any added pressure in the length and width directions. Kept the temperature and the pressure for greater than 30 minutes. The completely heated mold was then further compressed along the thickness direction while heating was ended. Then the mold was cooled with pressure 2.3 to 6.0 MPa. The stack was thus consolidated to a base layer thickness of about 16 mm and the temperature was decreased throughout the article to less than 290 degrees C. Then the temperature of and pressure on the stack were reduced to ambient conditions to obtain the composite material. The molded composite material has 91.5 cm of diameter, about 16.0 mm of stacked consolidated mats (base layer) thickness, 0.1 to 1.0 mm of PFA (intermediate layer) thickness, and 0.5 to 5.0 mm of PTFE or modified PTFE (cover layer) thickness.

### Examples 34 to 66 (Two Steps Molding Method)

The same process as of Examples 1 to 33 was conducted excepting for the PFA (intermediate layer) and PTFE or modified PTFE (cover layer) was not put in the mold. The stacked consolidated mats were hot pressed (molded) under the same conditions as disclosed in Examples 1 to 33. The molded consolidated mats without inter mediate layer and cover layer were obtained.

PTFE or modified PTFE (cover layer), and PFA (intermediate layer) disclosed in Table 2 were placed in a mold in the order. Then the obtained molded consolidated mats were placed on the PFA. The stack (i.e. PTFE or modified PTFE, PFA and molded consolidated mats) were hot pressed under the same conditions as disclosed in Examples 1 to 33.

The molded composite material has 91.5 cm of diameter, about 16.0 mm of stacked consolidated mats (base layer) thickness, 0.1 to 1.0 mm of PFA (intermediate layer) thickness, and 0.5 to 5.0 mm of PTFE or modified PTFE (cover layer) thickness.

### Analytical Method

### 1. Thermal Shock Testing

Test pieces were prepared by slicing and cutting from the obtained molded composite material. The base layer of the molded composite material was sliced to be 4.0 mm of thickness. Then, the molded material was cut from the width of 10 mm, and two holes (diameter is 3 mm) were drilled on the center of the plane of the test peace.

Thermal shock testing, also called temperature shock testing, exposes products to alternating cold and hot temperature cycles. Thermal shock testing is used to evaluate whether items can withstand sudden changes in temperature of the surrounding atmosphere without experiencing physical damage or degradation in performance. Test pieces were repeatedly immersed in hot silicone oil for heating up and picked up for cooling down with fan. Temperature setting 50 degrees C. as cold and 200 degrees C. as hot is used with duration 2,000 cycles to evaluate adhesion between base layer, intermediate layer and cover layer.

Fluorescent penetrant inspection was used to evaluate adhesion condition before and after thermal shock testing. In evaluation, fluorescent penetrant was pasted on test piece and wiped with solvent (ethanol). Then using black light, test piece was evaluated if there is any gap between layers. The result is shown in Tables 1 and 2.

### Appearance

◯: Good (No peeling off)
Δ: Fair (Peeling off partly)
x: Not good (Peeling off)

### Fluorescent Penetrant Inspection

◯: Good (No gap)
Δ: Fair (Tiny gap around 10 to 100 microns)
x: Not good (Remarkable gap)

TABLE 1

| | | Cover layer | | Fluorescent penetrant | |
|---|---|---|---|---|---|
| | | (PTFE or | | inspection | |
| | Intermediate | modified | | before | after |
| | layer (PFA) | PTFE)/ | | Thermal | Thermal |
| | thickness | thickness | | Shock | Shock |
| No. | (mm) | (mm) | Appearance | Testing | Testing |
| 1 | 0.5 | — | ◯ | ◯ | ◯ |
| 2 | 1.0 | — | ◯ | ◯ | ◯ |
| 3 | 2.0 | — | ◯ | ◯ | ◯ |
| 4 | — | PTFE/0.5 | ◯ | X | NA |
| 5 | — | PTFE/3.0 | X | NA | NA |
| 6 | — | PTFE/5.0 | X | NA | NA |
| 7 | 0.1 | PTFE/0.5 | ◯ | ◯ | ◯ |
| 8 | 0.1 | PTFE/3.0 | ◯ | ◯ | ◯ |
| 9 | 0.1 | PTFE/5.0 | ◯ | ◯ | ◯ |
| 10 | 0.25 | PTFE/0.5 | ◯ | ◯ | ◯ |
| 11 | 0.25 | PTFE/3.0 | ◯ | ◯ | ◯ |
| 12 | 0.25 | PTFE/5.0 | ◯ | ◯ | ◯ |
| 13 | 0.5 | PTFE/0.5 | ◯ | ◯ | ◯ |
| 14 | 0.5 | PTFE/3.0 | ◯ | ◯ | Δ |
| 15 | 0.5 | PTFE/5.0 | ◯ | ◯ | Δ |
| 16 | 1.0 | PTFE/0.5 | ◯ | ◯ | Δ |
| 17 | 1.0 | PTFE/3.0 | ◯ | ◯ | Δ |
| 18 | 1.0 | PTFE/5.0 | ◯ | ◯ | Δ |
| 19 | — | modified | X | NA | NA |
| | | PTFE/0.5 | | | |
| 20 | — | modified | X | NA | NA |
| | | PTFE/3.0 | | | |
| 21 | — | modified | X | NA | NA |
| | | PTFE/5.0 | | | |
| 22 | 0.1 | modified | ◯ | ◯ | ◯ |
| | | PTFE/0.5 | | | |
| 23 | 0.1 | modified | ◯ | ◯ | ◯ |
| | | PTFE/3.0 | | | |
| 24 | 0.1 | modified | ◯ | ◯ | ◯ |
| | | PTFE/5.0 | | | |
| 25 | 0.25 | modified | ◯ | ◯ | ◯ |
| | | PTFE/0.5 | | | |
| 26 | 0.25 | modified | ◯ | ◯ | ◯ |
| | | PTFE/3.0 | | | |
| 27 | 0.25 | modified | ◯ | ◯ | ◯ |
| | | PTFE/5.0 | | | |
| 28 | 0.5 | modified | ◯ | ◯ | ◯ |
| | | PTFE/0.5 | | | |
| 29 | 0.5 | modified | ◯ | ◯ | ◯ |
| | | PTFE/3.0 | | | |
| 30 | 0.5 | modified | ◯ | ◯ | ◯ |
| | | PTFE/5.0 | | | |
| 31 | 1.0 | modified | ◯ | ◯ | ◯ |
| | | PTFE/0.5 | | | |
| 32 | 1.0 | modified | ◯ | ◯ | ◯ |
| | | PTFE/3.0 | | | |
| 33 | 1.0 | modified | ◯ | ◯ | ◯ |
| | | PTFE/5.0 | | | |

TABLE 2

| | | Cover layer | | Fluorescent penetrant | |
|---|---|---|---|---|---|
| | | (PTFE or | | inspection | |
| | Intermediate | modified | | before | after |
| | layer (PFA) | PTFE)/ | | Thermal | Thermal |
| | thickness | thickness | | Shock | Shock |
| No. | (mm) | (mm) | Appearance | Testing | Testing |
| 34 | 0.5 | — | ◯ | ◯ | ◯ |
| 35 | 1.0 | — | ◯ | ◯ | ◯ |
| 36 | 2.0 | — | ◯ | ◯ | ◯ |
| 37 | — | PTFE/0.5 | ◯ | X | NA |
| 38 | — | PTFE/3.0 | X | NA | NA |
| 39 | — | PTFE/5.0 | X | NA | NA |
| 40 | 0.1 | PTFE/0.5 | ◯ | ◯ | Δ |
| 41 | 0.1 | PTFE/3.0 | ◯ | ◯ | Δ |
| 42 | 0.1 | PTFE/5.0 | ◯ | ◯ | Δ |
| 43 | 0.25 | PTFE/0.5 | ◯ | ◯ | Δ |
| 44 | 0.25 | PTFE/3.0 | ◯ | ◯ | Δ |
| 45 | 0.25 | PTFE/5.0 | ◯ | ◯ | Δ |
| 46 | 0.5 | PTFE/0.5 | ◯ | ◯ | Δ |
| 47 | 0.5 | PTFE/3.0 | ◯ | ◯ | Δ |
| 48 | 0.5 | PTFE/5.0 | ◯ | ◯ | Δ |
| 49 | 1.0 | PTFE/0.5 | ◯ | ◯ | Δ |
| 50 | 1.0 | PTFE/3.0 | ◯ | ◯ | Δ |
| 51 | 1.0 | PTFE/5.0 | ◯ | ◯ | Δ |
| 52 | — | modified | X | NA | NA |
| | | PTFE/0.5 | | | |
| 53 | — | modified | X | NA | NA |
| | | PTFE/3.0 | | | |
| 54 | — | modified | X | NA | NA |
| | | PTFE/5.0 | | | |
| 55 | 0.1 | modified | ◯ | ◯ | Δ |
| | | PTFE/0.5 | | | |
| 56 | 0.1 | modified | ◯ | ◯ | Δ |
| | | PTFE/3.0 | | | |
| 57 | 0.1 | modified | ◯ | ◯ | Δ |
| | | PTFE/5.0 | | | |
| 58 | 0.25 | modified | ◯ | ◯ | Δ |
| | | PTFE/0.5 | | | |
| 59 | 0.25 | modified | ◯ | ◯ | Δ |
| | | PTFE/3.0 | | | |
| 60 | 0.25 | modified | ◯ | ◯ | Δ |
| | | PTFE/5.0 | | | |
| 61 | 0.5 | modified | ◯ | ◯ | Δ |
| | | PTFE/0.5 | | | |
| 62 | 0.5 | modified | ◯ | ◯ | Δ |
| | | PTFE/3.0 | | | |
| 63 | 0.5 | modified | ◯ | ◯ | Δ |
| | | PTFE/5.0 | | | |
| 64 | 1.0 | modified | ◯ | ◯ | Δ |
| | | PTFE/0.5 | | | |
| 65 | 1.0 | modified | ◯ | ◯ | Δ |
| | | PTFE/3.0 | | | |
| 66 | 1.0 | modified | ◯ | ◯ | Δ |
| | | PTFE/5.0m | | | |

The result shows that cover layer can easily peel off if no intermediate layer is applied. and simultaneous molding with consolidated mats shows superior adhesion compared with additional molding on molded composite material.

What we claimed is:

1. A composite material comprising:
(A) a base layer comprising perfluoroalkoxy alkane and carbon fiber,
(B) an intermediate layer and
(C) a polytetrafluoroethylene cover layer,
wherein the intermediate layer comprises perfluoroalkoxy alkane.

2. The composite material of claim 1, wherein the coefficient of linear expansion of the base layer (A) is from 3 to 15×10⁻⁶/degrees C. and the coefficient of linear expansion of the PTFE cover layer is 120 to 220×10⁻⁶/degrees C.

3. The composite material of claim 1, wherein the base layer and PTFE cover layer is bonded after thermal shock test, by placing the composite material at 50 degrees C. then heated at 200 degrees C. as a cycle, repeated 2,000 times.

4. The composite material of claim 1, wherein the thickness of layer (B) is from 10 to 2,000 micrometers.

5. A process for preparing a composite material of claim 1, comprising the steps of:
(a) preparing consolidated mats comprising PFA and carbon fiber, and
(b) setting a cover layer, an intermediate layer and the multiple consolidated mats in a mold, then
(c) hot press the three components in the mold to form a composite material.

6. A process for preparing a composite material of claim 1, comprising the steps of:
(d) preparing consolidated mats comprising PFA and carbon fiber,
(e) setting multiple consolidated mats in a mold,
(f) hot press the multiple consolidated mats to form a molded material,
(g) setting a cover layer, an intermediate layer and the molded material in a mold,
(h) hot press the three components in the mold to form a composite material.

7. An article formed from the composite material of claim 1.

8. The article of claim 7 used for semiconductor manufacturing process.

9. The article of claim 7 used for chemical processing process.
